(19) United States
(12) Patent Application Publication
(10) Pub. No.: US 2006/0268725 A1
(43) Pub. Date: Nov. 30, 2006

(54) Operating network managers in verification mode to facilitate error handling of communications networks

(75) Inventors: Mark G. Atkins, Arvada, CO (US); John Divirgilio, Middletown, NY (US); Jay R. Herring, Hyde Park, NY (US); John Lewars, Middletown, NY (US); LeRoy R. Lundin, Hurley, NY (US); Nicholas P. Rash, Poughkeepsie, NY (US); Karen F. Rash, Poughkeepsie, NY (US); Alison B. White, Kingston, NY (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 11/137,834

(22) Filed: May 25, 2005

(51) Int. Cl. H04L 1/00

(52) U.S. Cl. 370/242; 370/252

(57) ABSTRACT

Network managers are operated in verification mode to facilitate error handling of communications networks. In verification mode, error reporting remains enabled, even for those components of a communications network reporting errors. A step-by-step procedure is provided for handling each type of error that is detected. Subsequent to handling any reported errors, the network manager is removed from verification mode and may be placed in production mode.

### TECHNICAL FIELD

This invention relates, in general, to communications networks, and in particular, to facilitating error handling of communications networks.

### BACKGROUND OF THE INVENTION

A communications network, such as a high performance switch network, is actively managed by a network manager. The network manager calculates routes and stores the calculated routes on adapters of the switch network. The network manager then begins to actively monitor for errors on network links of the switch network. When an error is detected, the network manager turns off error reporting for that link and changes the routes (e.g., the routing path tables) to path around the link.

This procedure of turning off error reporting and changing the routing path, when an error is detected, has various drawbacks. One such drawback is that one or more errors may not be reported, and thus, may not be handled appropriately. For instance, if various hardware components associated with the link are faulty, only the first reported error is handled. The other errors are not reported or are ignored, since error reporting is discontinued.

As a further example, if error reporting is disabled and a link is bypassed in the first occurrence of an error, then it cannot be determined if it is a one-time error or a persistent error that may need to be addressed differently than a one-time error.

As yet a further example, if a link is bypassed and then fixed, there is no immediate feedback as to the health of the link.

Based on the foregoing, a capability is needed for facilitating error handling in communications networks. For example, a capability is needed to enhance the detection and correction of errors of communications networks.

### SUMMARY OF THE INVENTION

The shortcomings of the prior art are overcome and additional advantages are provided through the provision of a method of facilitating error handling in communications networks. The method includes, for instance, initiating a network manager in verification mode, the network manager being coupled to the communications network, and wherein the verification mode is different from production mode in that error reporting remains enabled for a component of the communications network subsequent to detecting an error associated with that component; and using the network manager in verification mode to facilitate handling of one or more errors of the communications network.

System and computer program products corresponding to the above-summarized method are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one example of a switch network coupled to a service network, in accordance with an aspect of the present invention;

FIG. 2 depicts one embodiment of the logic associated with starting a network manager in service network verification mode in order to verify the service network of FIG. 1, in accordance with an aspect of the present invention;

FIG. 3 depicts one embodiment of the logic associated with starting the network manager in switch network verification mode in order to perform system-wide link verification, in accordance with an aspect of the present invention;

FIG. 4 depicts further details of the gathering of link errors step referred to in FIG. 3, in accordance with an aspect of the present invention;

FIG. 5 depicts one embodiment of the logic associated with adapter-to-switch link verification, in accordance with an aspect of the present invention;

FIG. 6 depicts one embodiment of the logic associated with exercising the switch network, in accordance with an aspect of the present invention;

FIG. 7 depicts one example of a node executing an exerciser used to exercise the network, as described with reference to FIG. 6, in accordance with an aspect of the present invention; and

FIG. 8 depicts one embodiment of a computer program product embodying one or more aspects of the present invention.

### BEST MODE FOR CARRYING OUT THE INVENTION

In accordance with an aspect of the present invention, a network manager is placed in a special mode of operation, referred to herein as verification mode, in order to facilitate error handling of a communications network. In verification mode, hardware error reporting is not disabled, and the network manager does no route modification. Instead, the network links are kept active, so that errors can be reported, isolated and investigated in a controlled manner. A step-by-step procedure for isolating, diagnosing and handling faulty hardware is provided. The procedure is performed iteratively until the faulty hardware has been identified and the errors have been appropriately handled. Subsequent to identifying and handling errors of the faulty hardware, the switch network is ready to be used in production mode.

Production mode differs from verification mode in that in production mode, when an error is encountered, error reporting is disabled for at least the link reporting the error and the faulty link is bypassed. Production mode is designed to provide maximum production performance for client applications. In order to provide maximum performance, faulty links are routed around, so that they do not interfere with successful communications between nodes. In some cases, in routing around certain faulty links, other good links are necessarily routed around because they are used in conjunction with the faulty link. In production mode, error reporting is kept active only so long as it is required to create a serviceable event by which service personnel may be notified of a faulty device, so that a repair action may be scheduled.

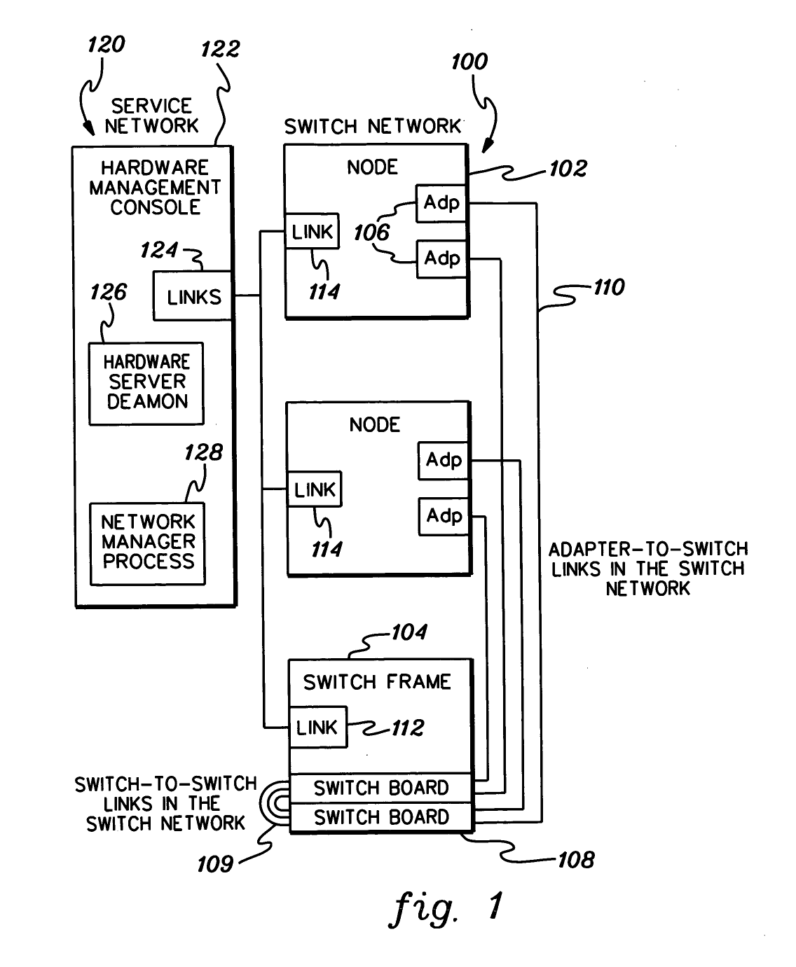

One embodiment of a communications network incorporating and using one or more aspects of the present invention is described with reference to FIG. 1. A communications network 100 is, for instance, a switch network that may be optical, copper, phototonic, etc., or any combination thereof. As is known, a switch network is used in communicating between computing units (e.g., processors) of a system, such as a central processing complex. The processors may be, for instance, pSeries processors or other processors, offered by International Business Machines Corporation, Armonk, N.Y. One switch network offered by International Business Machines Corporation is the High Performance Switch (HPS) network, an embodiment of which is described in “An Introduction to the New IBM eServer pSeries High Performance Switch,” SG24-6978-00, December 2003, which is hereby incorporated herein by reference in its entirety.

Switch network 100 includes, for example, a plurality of nodes 102, such as Power 4 nodes offered by International Business Machines Corporation, Armonk, N.Y., coupled to one or more switch frames 104. A node 102 includes, as an example, one or more adapters 106 (or other network interfaces) coupling nodes 102 to switch frame 104. Switch frame 104 includes, for instance, a plurality of switch boards 108, each of which is comprised of one or more switch chips. Each switch chip includes one or more external switch ports, and optionally, one or more internal switch ports. A switch board 108 is coupled to one or more other switch boards via one or more switch-to-switch links 109 in the switch network. Further, one or more switch boards are coupled to one or more adapters of one or more nodes of the switch network via one or more adapter-to-switch links 110 of the switch network.

Switch frame 104 also includes at least one link 112 coupling the switch frame to a service network 120. Similarly, a node 102 includes, for instance, one or more links 114 coupling the node to service network 120.

Service network 120 is an out-of-band network that provides various services to the switch network. In this particular situation, the service network is responsible for verifying the health of the switch network. In one example, service network 120 includes a hardware management console 122 having, for instance, one or more links 124 which are coupled to one or more links 114 of nodes 102 and/or one or more links 112 of switch frame 104. Hardware management console 122 executes a hardware server daemon 126 that is a continuously running service process that monitors the set of devices that is visible from the hardware management console. The hardware management console also executes at least one network manager process 128 (also referred to herein as the network manager) that is responsible for verifying the switch network, as well as the service network. It is the network manager process that is used to facilitate error handling, as described herein.

In accordance with an aspect of the present invention, in order to facilitate error handling, the network manager is placed in verification mode, which enables error reporting to remain active, even when errors are encountered, and allows the network manager to facilitate error handling. When the network manager is started in verification mode, the network is initialized to the extent desired to allow error reporting. For instance, the switches are initialized to enable the discovery of the network topology, and then, the nodes and adapters are initialized.

In verification mode, errors are detected, isolated and handled in an appropriate manner. As one example, there are two forms of verification mode: service network verification mode and switch network verification mode (collectively referred to herein as verification mode). Service network verification mode is used to verify the service network, and switch network verification mode is used to verify the switch network.

Verification mode includes, for instance, four phases of processing: verifying the service network; verifying the system-wide links; verifying the adapter-to-switch links; and exercising the network. Each of these phases is described in further detail below.

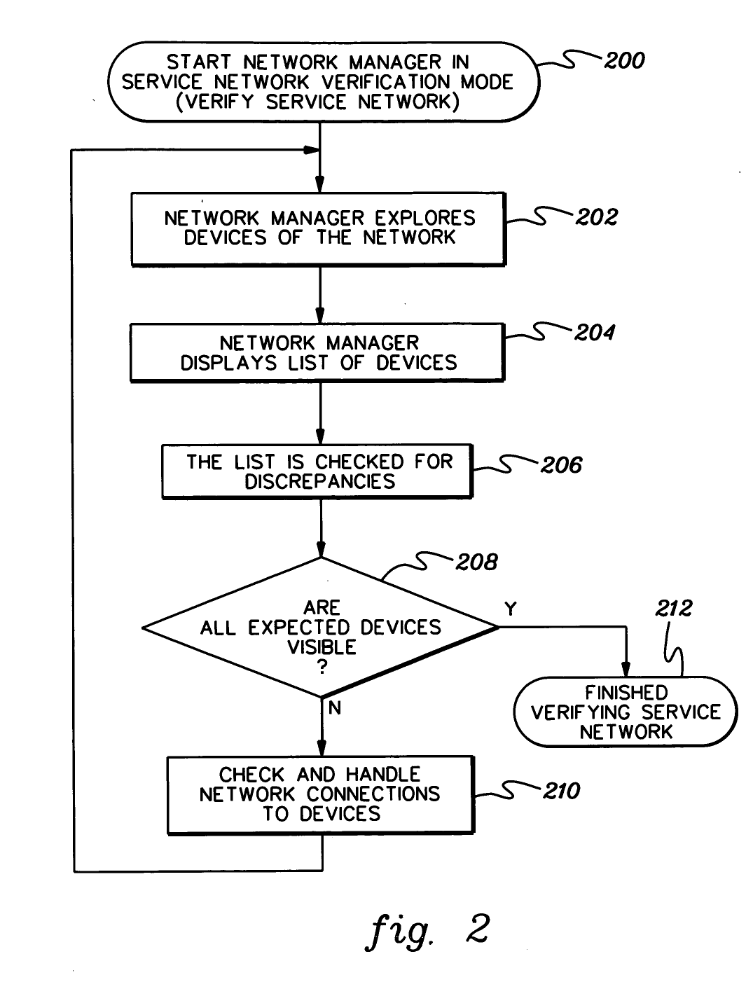

With the first phase, verifying the service network, the network manager verifies that it can communicate with the devices (e.g., nodes, switches) of the switch network. The network manager checks whether the links between the hardware management console of the service network and the devices of the switch network are functional. One embodiment of the logic associated with verifying the service network is described with reference to FIG. 2.

Initially, the network manager is started in service network verification mode, STEP 200. As one example, a graphical user interface (GUI) associated with the network manager is provided, which offers the choice of starting the network manager in service network verification mode, switch network verification mode or production mode. In this instance, service network verification mode is selected, which causes an indicator, such as a flag, to be set specifying to the network manager that it is in service network verification mode. As a further example, a command entered on a command line may be used to place the network manager in service network verification mode. When in service network verification mode, the network manager does not turn error reporting off during the process of verifying the service network, even if an error is encountered.

Subsequent to being started, the network manager explores the state of the devices of the switch network, STEP 202. In particular, the network manager establishes a socket connection with the hardware server daemon, which is kept open, and the hardware server daemon provides various services to the network manager that facilitates the network manager in determining which devices are visible to the service network. These services include: 1) responding to a query about what hardware is currently visible to the hardware server daemon, and returning the data in list format; and 2) allowing a client, such as the network manager, to register to hear about hardware that becomes visible via the process described herein.

In one example, to determine whether a device of the switch network is visible to the service network, the hardware server daemon inspects the /dev/tty/ directory and looks for character special files with a particular prefix on the name, indicating that they are for link connections to the hardware management console. The hardware server daemon tries to set up an active serial connection for each applicable /dev/tty file that it finds. If successful in establishing the connection, then there is an active component on the other end of the line (e.g., connections to nodes; connections to switch frames). If it fails to set up an active connection on any given serial port, the hardware server daemon periodically retries to establish the connection. Thus, if a connection cannot be established, but later the connection is secured or repaired, so that the connection can be established, the hardware server daemon will make the connection when it retries. Hence, hardware that is not visible at first may become visible later.

Subsequent to the network manager receiving the list or other indication of visible devices, the network manager displays on the GUI the list of devices with which the network manager can communicate, STEP 204. Thereafter, this list is checked for discrepancies, STEP 206. As examples, an administrator can visually check the list for discrepancies or computer program code can be written which compares the list of devices with a list of expected devices and indicates any discrepancies.

Subsequent to checking the list, a determination is made as to whether all expected devices are visible, INQUIRY 208. That is, a determination is made as to whether any discrepancies were reported. If the network manager cannot communicate with all the expected devices, then the network connections to the devices are checked, STEP 210. In one example, this is accomplished by visual inspection performed by a service provider and/or running available diagnostics that check the connections and/or cables/links. Thereafter, any errors are handled, including performing repairs or removing a bad cable or link. These repairs may include tightening a loose connection, replacing a cable or link, correcting internet protocol (IP) assignments, etc. Subsequently, processing continues with the network manager making another pass of the devices, STEP 202.

Returning to INQUIRY 208, when the network manager can communicate with all of the expected devices, then verification of the service network is finished, STEP 212, completing the first phase of verification.

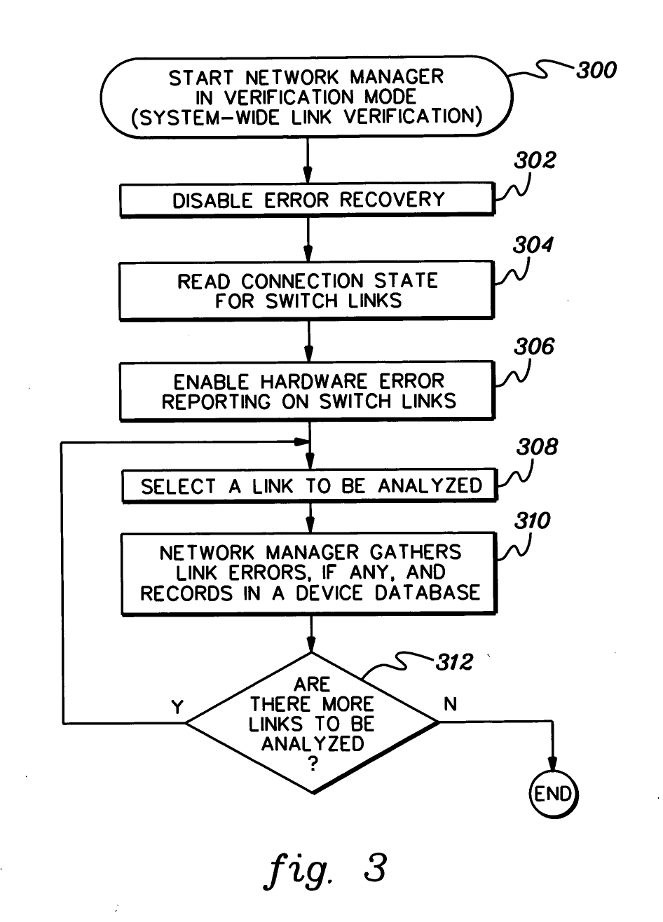

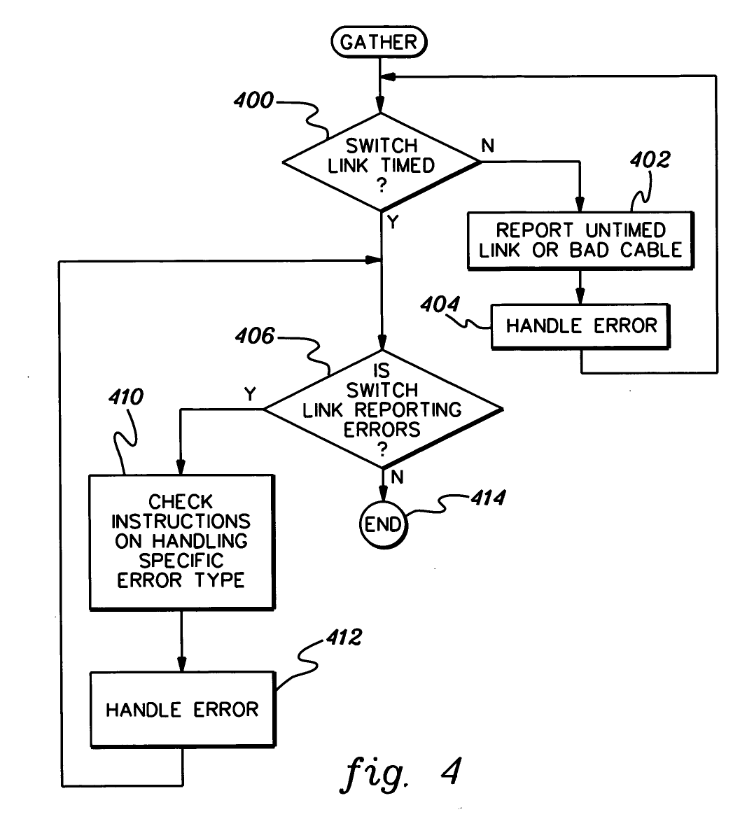

In the second phase of verification, the network manager performs system-wide link verification of the switch network. One embodiment of the logic associated with verifying the switch-to-switch links of the switch network is described with reference to FIGS. 3 and 4.

With reference to FIG. 3, initially, the network manager is started in switch network verification mode, in a similar manner to that described above, STEP 300. In switch network verification mode, the network is initialized sufficiently for error reporting to be enabled and for routes to be generated and written to the adapters.

Next, error recovery is disabled in the network manager by setting, for instance, an indicator specifying that error reporting is to continue even in the presence of errors, STEP 302. By disabling error recovery, errors continue to be visible until they are appropriately handled. As examples, this indicator may be set by selecting pertinent information entered by a user on the GUI, or it may be automatically set by the logic of the network manager when the network manager, is placed in verification mode.

Thereafter, the connection state for the switch-to-switch links is obtained, STEP 304. In one example, this connection state is maintained in one or more hardware registers on the switch, and the state is obtained by reading the state from the hardware registers. This state is provided to the registers by the hardware switch-to-switch links, themselves, and it includes the state of the functional paths of the switch-to-switch links.

In addition to the above, hardware error reporting on the switch links is enabled, STEP 306. This is accomplished, in one example, by writing to the registers on the switch an indication that error reporting is enabled (e.g., setting a specific indicator in one or more registers).

Thereafter, a switch-to-switch link to be analyzed is selected, STEP 308, and the network manager gathers any link errors associated with the selected link and records those errors in a device database, STEP 308. One embodiment of the logic associated with gathering link errors is described with reference to FIG. 4. This logic is performed by the network manager for each switch-to-switch link of the switch network.

Referring to FIG. 4, initially, a determination is made as to whether the switch link is timed, INQUIRY 400. That is, a determination is made as to whether the particular switch-to-switch link being analyzed is active and operating correctly (e.g., self-timing completed properly; in good state). To make this determination, the network manager consults the connection state read in STEP 304 of FIG. 3.

If the switch link is not timed, then the untimed link or bad cable is reported, STEP 402 (FIG. 4), and that error is handled appropriately, STEP 404. For instance, the connection is checked and if loose, tightened; a bad cable is replaced; etc. Thereafter, processing returns to INQUIRY 400.

If the switch link is timed, then a further determination is made as to whether the switch link is reporting errors to the network manager, INQUIRY 406. In one example, the switch link asynchronously notifies the network manager of errors and the errors are displayed on the GUI. Thereafter, the GUI may be physically inspected for reported errors or the network manager may automatically notify a piece of code or logic regarding the errors.

Should the switch-to-switch link be reporting one or more errors, then the network manager provides instructions on how to handle each specific type of error being reported, STEP 410. The providing of instructions includes listing the instructions on a GUI, providing a reference indicator of where to locate the instructions, such as a publication number, or any combination thereof, as examples. There are many ways to provide the instructions. In one particular example, a graphical user interface (GUI) help panel is provided that specifies the instructions for handling specific error types and these instructions are followed to handle the particular error, STEP 412. As examples, one or more steps of the instructions are performed manually by service providers, automatically by computer code or logic or by machine, or any combination thereof.

One example of step-by-step instructions to handle a particular error is as follows:

Assume the network manager GUI display shows a status of “Not Operational” or “SVC Required” for ports 4, 5, 6, or 7:

1) The problem is on a switch planar, so ignore any errors reported on ports, 0, 1, 2, or 3;

2) Determine which planar is reporting the fault by looking at the cage id in the display;

3) Replace the planar; and

4) Refresh the GUI display.

The above is only one example of how to address a “Not Operational” or “SVC Required” error. Other techniques may be provided without departing from the spirit of the present invention. Moreover, other step-by-step instructions are provided for other types of errors. The specific instructions are not pertinent for this aspect of the present invention, just that step-by-step instructions are provided to handle the specific errors. Subsequent to handling the error for the switch-to-switch link being analyzed, processing continues with STEP 406.

If the switch link is not reporting errors, then the gather step for this particular link is complete, STEP 414, and processing continues with INQUIRY 312 of FIG. 3.

At INQUIRY 312, a check is made as to whether there are more links to be analyzed. If so, then processing continues with STEP 308. Otherwise, system-wide link verification and phase two are complete.

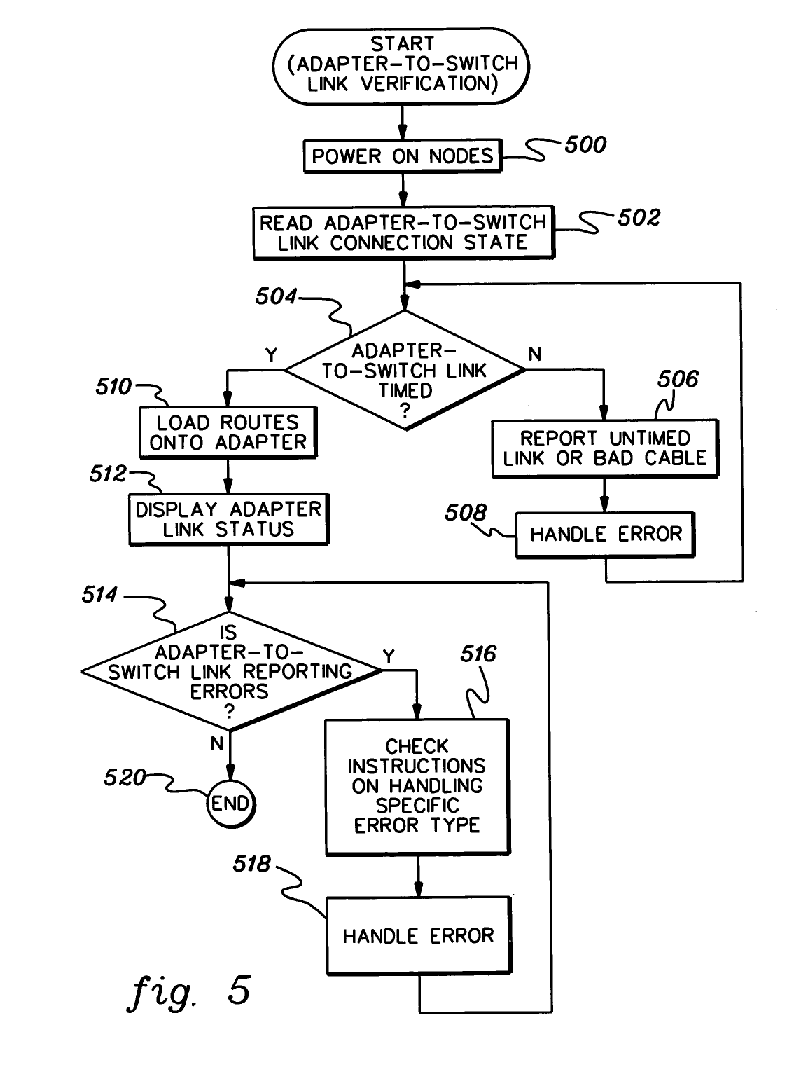

A third phase of verification includes verifying the adapter-to-switch links of the switch network. One embodiment of the logic associated with this processing is described with reference to FIG. 5. This logic is iteratively performed by the network manager for each of the adapter-to-switch links in the switch network.

Initially, the nodes of the switch network (e.g., nodes 102 of FIG. 1) are powered on, STEP 500. Thereafter, adapter-to-switch link connection state is read from one or more hardware registers of the adapters, STEP 502. It is the adapters that place this state in the registers. From this state, a determination is made as to whether the adapter-to-switch link is timed, INQUIRY 504. If the adapter-to-switch link is not timed, then the untimed link or bad cable is reported, STEP 506, and the error is appropriately handled, STEP 508. For instance, the physical link connection is tightened, a bad cable is replaced, etc. Thereafter, processing continues with INQUIRY 504.

If the adapter-to-switch link is timed, routes are loaded onto the adapter in a known manner, STEP 510, and the adapter link status is displayed, STEP 512. For example, the status of the adapter-to-switch link is displayed on the GUI. Subsequently, a determination is made as to whether this adapter-to-switch link is reporting errors, INQUIRY 514. This determination is made based on the displayed status.

If one or more errors are being reported, then the network manager provides step-by-step instructions as to how to handle the specific error type, STEP 516. Once again, the providing of instructions includes listing the instructions on a GUI, providing a reference indicator of where to locate the instructions, such as a publication number, or any combination thereof, as examples. There are many ways to provide the instructions. In one particular example, a graphical user interface help panel is provided that specifies the step-by-step instructions for the particular error. Such instructions may include, for instance, check the cable connections for loose cables or broken pins; run diagnostics procedures and make repairs per their isolation instructions; and if diagnostics do not fail, make repairs according to the ordered list of field replaceable units found in the serviceable event. The provided instructions are followed (e.g., by an administrator, computer code, and/or machine) to handle the particular error, STEP 518, and processing continues with INQUIRY 514.

If no errors are being reported for the link being analyzed, ideal routes are computed and written to the adapter hardware. Ideal routes are route tables that are computed with the assumption of 0 faulty network links. Thereafter, verification of the adapter-to-switch link is complete, STEP 520. This process is iteratively repeated, in this embodiment, for all of the adapter-to-switch links, and when there are no reported errors on any of the links, the third phase of verification is complete.

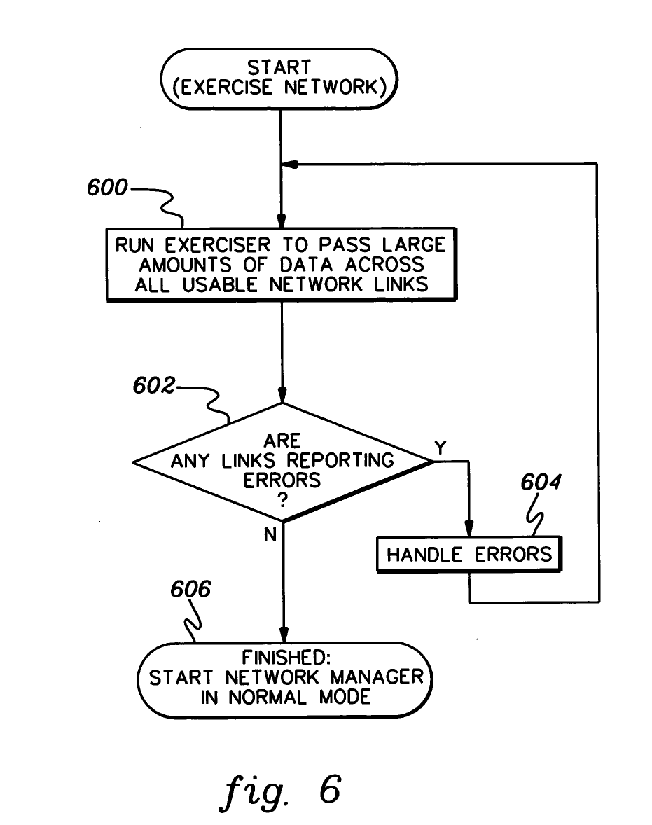

The last phase of verification includes exercising the network. In this phase, network links are exercised using stress tests that send a high volume of packet data through the routes of the adapters. Switch hardware error reporting remains enabled and no route modifications are performed, so that failures surface immediately and are reported. The same or similar step-by-step procedures to those described above are used to isolate and repair faulty hardware. One embodiment of the logic associated with exercising the network is described with reference to FIG. 6.

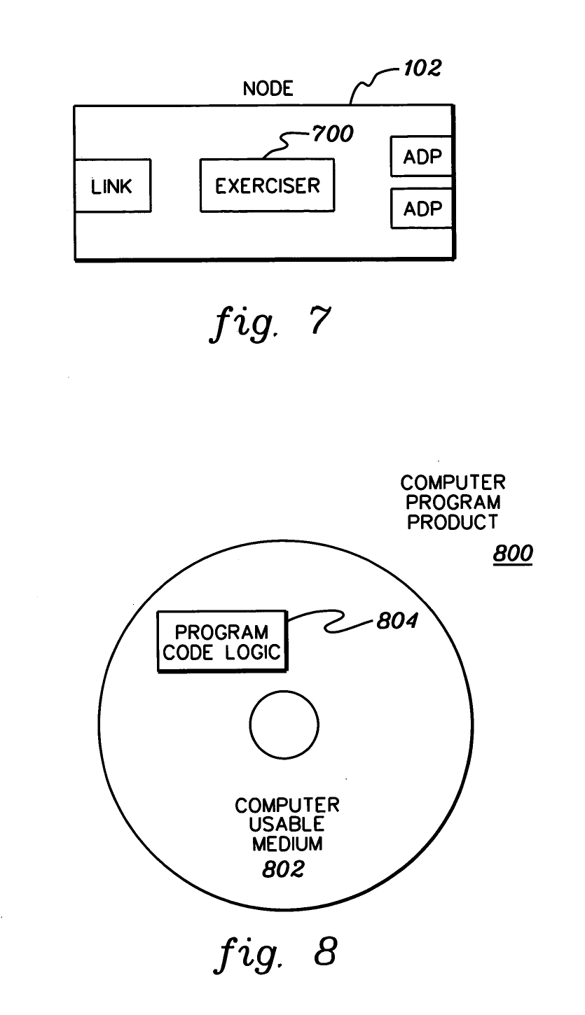

An exerciser 700 (FIG. 7) (e.g., computer code running in one or more nodes) is executed that passes large amounts of data across the usable network links, STEP 600. For example, the code sends a large number of messages, a large amount of data, or a combination thereof, to stress the links.

During this exercise, a determination is made as to whether any links (e.g., switch-to-switch links; adapter-to-switch links) are reporting errors, INQUIRY 602. If any link is reporting an error, then each error is handled appropriately, STEP 604, as described above, and processing continues with STEP 600. However, if no link is reporting an error during the exercise routine, then verification is complete, STEP 606. Thus, the network manager may be started in normal or production mode. In this mode, if a link error is encountered, then error reporting is disabled for that link and the routing path tables are changed to path around the faulty link.

Described in detail above is a capability for verifying a switch network or other communications network. This capability includes a technique for facilitating the handling of network errors, such as errors reported on switch-to-switch and adapter-to-switch links. Advantageously, this capability enables error reporting to remain active, even for those links reporting errors. That is, the way error reporting is handled on the network is changed. Now, there are two different modes: fault tolerant mode and non-tolerant mode. By allowing fault tolerant mode, hardware errors of the network, including latent errors, can be detected and handled appropriately (e.g., fixed, eliminated, etc.).

Advantageously, one or more aspects of the present invention can be used to verify hardware of a network prior to the network going into production or whenever there is a situation that it would be beneficial to verify the health of the network, such as after repairs, upgrades, etc. Current failures are detected, as well as those caused by stressing the hardware and firmware. Links are stress tested and routes are implicitly validated before being placed in production. In one embodiment, it is assumed that the communications routes in the network are valid.

Advantageously, aspects of the present invention work for different types of networks including, but not limited to, optical, copper, phototonic networks, or a combination thereof.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

One example of an article of manufacture or computer program product incorporating one or more aspects of the present invention is described with reference to FIG. 8. A computer program product 800 includes, for instance, one or more computer usable media 802, such as, a floppy disk, a high-capacity read-only memory in the form of an optically read compact disk or CD-Rom, a tape, a transmission type media, such as a digital or analog communications link, or other recording media. Recording medium 802 stores computer readable program code means or logic 804 thereon to provide and facilitate one or more aspects of the present invention.

A sequence of program instructions or a logical assembly of one or more interrelated modules defined by one or more computer readable program code means or logic direct components of the service network and/or switch network to perform one or more aspects of the present invention.

The capabilities of one or more aspects of the present invention can be implemented in software, firmware, hardware or some combination thereof. At least one program storage device readable by a machine embodying at least one program of instructions executable by the machine to perform the capabilities of the present invention can be provided.

Although examples are described herein, many variations to these examples may be provided without departing from the spirit of the present invention. For instance, switch networks other than the high performance switch network offered by International Business Machines Corporation, may be verified using one or more aspects of the present invention. Similarly, other types of networks may also be verified using one or more aspects of the present invention. Further, the switch network described herein may include more, less or different devices than described herein. For instance, it may include less, more or different nodes than described herein, as well as less, more or different switch frames than that described herein. Additionally, the links, adapters, switches and/or other devices or components described herein may be different than that described and there may be more or less of them. A device is defined as a node, switch or any other component to which the service network is attached. Further, the service network may include less, additional or different components than that described herein.

Additionally, although four phases of processing are described herein, one or more of the phases may be eliminated or combined with other phases. For example, it may be desired to forego the service network verification or to perform less, different or even additional steps than that described herein. Additionally, the exercise phase may be optional. For instance, it may be decided after going through one or more of the other phases, that the exercise phase may be not be needed. Further, the exercise phase may be performed alone and without the benefit of the other phases. Further, the phases may be performed in a different order, in other embodiments.

As a further example, although it is described herein that there are different verification modes, such as verification mode for the service network and verification mode for the switch network, in another example, the network manager may be placed in one verification mode that covers both the service network and the switch network.

In yet other embodiments, components other than network managers may perform one or more aspects of the present invention. Further, the network manager may be a part of the communications environment, separate therefrom or a combination thereof.

Additionally, the network can be in a different environment than that described herein. Many other variations are considered to be included within the scope of the claimed invention.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of facilitating error handling in communications networks, said method comprising:
initiating a network manager in verification mode, said network manager being coupled to a communications network, and wherein said verification mode is different from production mode in that error reporting remains enabled for a component of the communications network subsequent to detecting an error associated with that component; and
using the network manager in verification mode to facilitate handling of one or more errors of the communications network.

2. The method of claim 1, wherein the using the network manager to facilitate handling of one or more errors comprises:
detecting, by the network manager, the one or more errors; and
facilitating, by the network manager, repairing of the one or more errors.

3. The method of claim 2, wherein the detecting comprises checking by the network manager one or more hardware registers of one or more components of the communications network to determine that the one or more errors are being reported.

4. The method of claim 3, wherein the communications network is a switch network and the one or more components comprise at least one of one or more switch-to-switch links and one or more adapter-to-switch links.

5. The method of claim 2, wherein the facilitating repairing comprises providing, by the network manager, one or more step-by-step procedures to be used in repairing the one or more errors.

6. The method of claim 1, wherein the network manager is part of a service network coupled to the communications network, and said method further comprises verifying that the service network can communicate with selected devices of the communications network.

7. The method of claim 6, wherein the selected devices include at least one network node and one or more switches, and wherein a component of the communications environment comprises at least one of a link between a network node of the at least one network node and a switch of the one or more switches and a link between a plurality of switches of the one or more switches.

8. The method of claim 1, further comprising stressing one or more components of the communications network to verify that the communications network is in a desired state.

9. The method of claim 8, wherein the one or more components comprise one or more links of the communications environment, and said stressing comprises executing an exerciser in a node of the communications environment to pass data across the one or more links to stress the one or more links.

10. The method of claim 9, further comprising determining whether an error is being reported by one or more of the stressed links, wherein no reported errors verifies that the communications network is in a desired state of healthy.

11. The method of claim 1, wherein the handling of one or more errors comprises performing a plurality of processing phases including verifying a service network coupled to the communications network, verifying switch-to-switch links of the communications network, verifying adapter-to-switch links of the communications network and exercising the communications network, and wherein the network manager is used in one or more of the processing phases.

12. A system of facilitating error handling in communications networks, said system comprising:
a network manager initiated in verification mode, said network manager being coupled to a communications network, and wherein said verification mode is different from production mode in that error reporting remains enabled for a component of the communications network subsequent to detecting an error associated with that component; and
the network manager being adapted to be used in verification mode to facilitate handling of one or more errors of the communications network.

13. The system of claim 12, wherein the network manager being adapted to be used to facilitate handling of one or more errors comprises:
the network manager being adapted to detect the one or more errors; and
the network manager being adapted to facilitate repairing of the one or more errors.

14. The system of claim 12, wherein the network manager is part of a service network coupled to the communications network, and said system further comprises means for verifying that the service network can communicate with selected devices of the communications network.

15. The system of claim 12, further comprising an exerciser to stress one or more components of the communications network to verify that the communications network is in a desired state.

16. The system of claim 12, wherein the handling of one or more errors comprises performing a plurality of processing phases including verifying a service network coupled to the communications network, verifying switch-to-switch links of the communications network, verifying adapter-to-switch links of the communications network and exercising the communications network, and wherein the network manager is used in one or more of the processing phases.

17. An article of manufacture comprising:
at least one computer usable medium having computer readable program code logic to manage facilitating error handling in communications networks, the computer readable program code logic comprising:
initiate logic to initiate a network manager in verification mode, said network manager being coupled to a communications network, and wherein said verification mode is different from production mode in that error reporting remains enabled for a component of the communications network subsequent to detecting an error associated with that component; and
use logic to use the network manager in verification mode to facilitate handling of one or more errors of the communications network.

18. The article of manufacture of claim 17, wherein the use logic to use the network manager to facilitate handling of one or more errors comprises:
detect logic to detect, by the network manager, the one or more errors; and
facilitate logic to facilitate, by the network manager, repairing of the one or more errors.

19. The article of manufacture of claim 17, further comprising stress logic to stress one or more components of the communications network to verify that the communications network is in a desired state.

20. The article of manufacture of claim 17, wherein the handle logic to handle of one or more errors comprises perform logic to perform a plurality of processing phases including verifying a service network coupled to the communications network, verifying switch-to-switch links of the communications network, verifying adapter-to-switch links of the communications network and exercising the communications network, and wherein the network manager is used in one or more of the processing phases.
